(19) United States
(12) Patent Application Publication
(10) Pub. No.: US 2008/0224956 A1
(43) Pub. Date: Sep. 18, 2008

(54) Plasma display panel

(76) Inventor: Jung-Suk Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/071,975

(22) Filed: Feb. 28, 2008

(30) Foreign Application Priority Data
Mar. 12, 2007 (KR) 10-2007-0024206

(51) Int. Cl. G09G 3/28

(52) U.S. Cl. 345/60

(57) ABSTRACT

A plasma display panel (PDP) includes first and second substrates facing one another, a plurality of discharge electrodes, a plurality of first address electrodes, the plurality of first address electrodes having a first surface area and spaced apart from the discharge electrodes by a first vertical distance, and a plurality of second address electrodes, the plurality of second address electrodes having a second surface area and spaced apart from the discharge electrodes by a second vertical distance, the second surface area and second vertical distance being different than the first surface area and first vertical distance.

### BACKGROUND OF THE INVENTION

1. Field of the Invention

Embodiments of the present invention relate to a plasma display panel. More particularly, embodiments of the present invention relate to a plasma display panel having an electrode structure capable of providing an improved discharged uniformity and a reduced risk of short circuit therein.

2. Description of the Related Art

In general, plasma display panels (PDPs) refer to flat display panels capable of displaying images via gas discharge phenomenon. A conventional PDP may include front and rear panels having discharge electrodes thereon, a plurality of barrier ribs that define a plurality of discharge cells between the front and rear panels, a photoluminescent material coated on the barrier ribs, and discharge gas in each discharge cell. More specifically, application of voltage via the discharge electrodes to the discharge cells, i.e., discharge gas, may generate vacuum ultraviolet (VUV) light therein, thereby triggering excitation of the photoluminescent material to emit visible light.

A PDP having a large screen resolution may require an increased number of discharge electrodes therein, thereby necessitating a reduced space between the discharge electrodes. However, a reduced space between the discharge electrodes may increase a potential risk of short-circuit between adjacent discharge electrodes or signal transmission elements thereof. Accordingly, there exists a need for a PDP having an increased number of discharge electrodes that is capable of maintaining a uniform discharge and a low risk of short circuit therebetween.

### SUMMARY OF THE INVENTION

Embodiments of the present invention are therefore directed to a plasma display panel (PDP), which substantially overcomes one or more of the disadvantages of the related art.

It is therefore a feature of an embodiment of the present invention to provide a PDP having an increased number of discharge electrodes, while maintaining a low risk of short circuit therebetween.

It is another feature of an embodiment of the present invention to provide a PDP having a uniform discharge therein.

It is yet another feature of an embodiment of the present invention to provide a PDP exhibiting improved reliability.

It is still another feature of an embodiment of the present invention to provide a signal transmission element for a PDP having any one of the above features.

At least one of the above and other features and advantages of the present invention may be realized by providing a PDP including first and second substrates facing one another, a plurality of discharge electrodes, a plurality of first address electrodes, the plurality of first address electrodes having a first surface area and spaced apart from the discharge electrodes by a first vertical distance, and a plurality of second address electrodes, the plurality of second address electrodes having a second surface area and spaced apart from the discharge electrodes by a second vertical distance, the second surface area and second vertical distance being different than the first surface area and first vertical distance. Each of the first address electrodes may be adjacent to at least one second address electrode.

The PDP may further include a lower dielectric layer on the first address electrodes. The lower dielectric layer may include a first lower dielectric portion on the first address electrodes and a second lower dielectric portion on the second address electrodes.

The second vertical distance of the second address electrodes may be shorter than the first vertical distance of the first address electrodes. The first surface area of the first address electrodes may be larger than a second surface area of the second address electrodes. The first address electrodes may be wider than the second address electrodes. The first address electrodes may have different lengths as compared to the second address electrodes. The first address electrodes may be longer than the second address electrodes. The first address electrodes may include protrusions protruding from linear extensions. The protrusions of the first address electrodes may correspond to the Y transparent electrodes.

The discharge electrodes may include pairs of X electrodes and Y electrodes.

Each X electrode may include a X bus electrode and a plurality of first X transparent electrodes, and each Y electrode may include a Y bus electrode and a plurality of first Y transparent electrodes. Each Y electrode may further include a plurality of second Y transparent electrodes, the second Y transparent electrodes having a larger surface area than the first Y transparent electrodes. The second Y transparent electrodes may be wider than the first Y transparent electrodes. The second Y transparent electrodes may correspond to the first address electrodes. Further, each X electrode may also include a plurality of second X transparent electrodes, the second X transparent electrodes having a larger surface area than the first X transparent electrodes. The second X transparent electrodes may be wider than the first X transparent electrodes and correspond to the first address electrodes.

At least one of the above and other features and advantages of the present invention may be further realized by providing a PDP including first and second substrates facing one another, a plurality of first and second discharge electrodes, the plurality of first discharge electrodes having a larger surface area as compared to the second discharge electrodes, a plurality of first address electrodes spaced apart from the first discharge electrodes by a first vertical distance, and a plurality of second address electrodes spaced apart from the second discharge electrodes by a second vertical distance, the second vertical distance being shorter than the first vertical distance. The first discharge electrodes may include first transparent electrodes and the second discharge electrodes may include second transparent electrodes, the first transparent electrodes being wider than the second transparent electrodes.

At least one of the above and other features and advantages of the present invention may also be realized by providing a PDP signal transmission element, including a base member, at least one driving integrated circuit, a plurality of first terminals on the base member having a first width, and a plurality of second terminals on the base member having a second width smaller than the first width.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded perspective view of a plasma display panel (PDP) according to an embodiment of the present invention;

FIG. 2 illustrates a cross-sectional view along line II-II of FIG. 1;

FIG. 3 illustrates a perspective view of a signal transmission element in the PDP of FIG. 1;

FIG. 4 illustrates a plan view of a PDP according to another embodiment of the present invention;

FIG. 5 illustrates an exploded perspective view of a PDP according to another embodiment of the present invention;

FIG. 6 illustrates a cross-sectional view along line VI-VI of FIG. 5; and

FIG. 7 illustrates a cross-sectional of a PDP according to another embodiment of the present invention.

### DETAILED DESCRIPTION OF THE INVENTION

Korean Patent Application No. 10-2007-0024206, filed on Mar. 12, 2007, in the Korean Intellectual Property Office, and entitled: “Plasma Display Panel and Signal Transmission Element Connected to the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions are exaggerated for clarity of illustration. It will also be understood that when a layer or element is referred to as being “on” another layer, element, or substrate, it can be directly on the other layer, element, or substrate, or intervening layers or elements may also be present. Further, it will be understood that when a layer or element is referred to as being “under” another layer or element, it can be directly under, or one or more intervening layers or elements may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

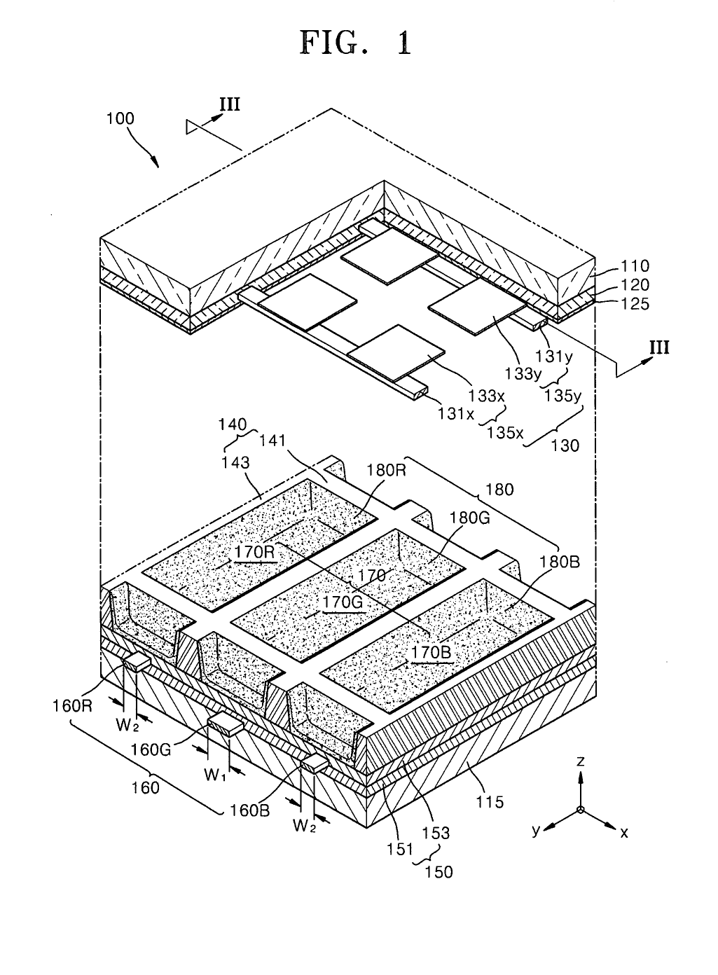

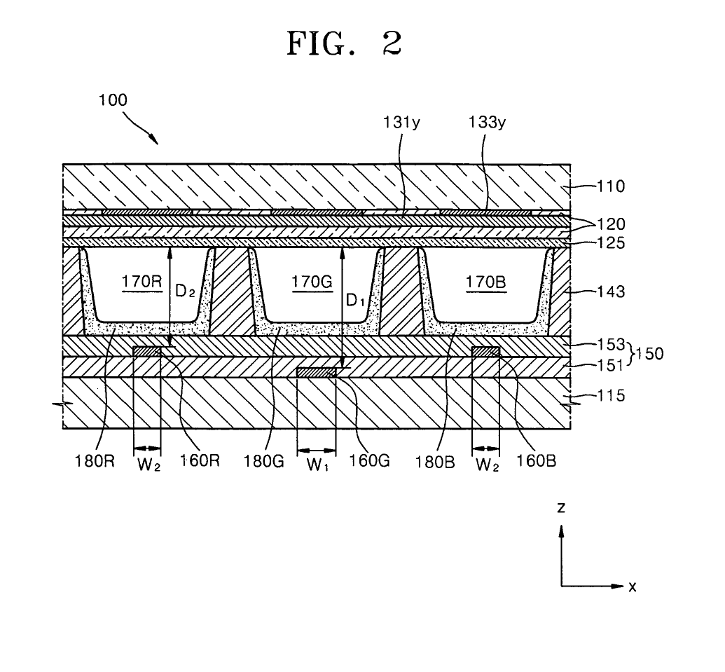

An exemplary embodiment of a plasma display panel (PDP) according to the present invention will now be described more fully with reference to FIGS. 1-3. As illustrated in FIGS. 1-2, a PDP 100 may include a first substrate 110, a second substrate 115, a plurality of barrier ribs 140 between the first and second substrates 110 and 115, a plurality of discharge electrodes 130, and a plurality of address electrodes 160.

The first and second substrates 110 and 115 may be spaced apart and face each other. An insulating material, e.g., frit glass, may be applied to peripheral portions of inner surfaces of the first and second substrates 110 and 115 to facilitate attachment therebetween. Accordingly, a sealed discharge space may be formed between the first and second substrates 110 and 115, so that the plurality of barrier ribs 140 may define a plurality of discharge cells 170 therein. Each of the first and second substrates 110 and 115 may be formed of a transparent material, e.g., a soda lime glass, a semitransparent material, a reflective material, a colored material, and so forth. “Inner surfaces” hereinafter refer to surfaces of elements facing the discharge space.

The barrier ribs 140 of the PDP 100 may include first barrier ribs 141 extending along the x-axis, and second barrier ribs 143 extending along the y-axis and intersecting with the first barrier ribs 141. Accordingly, the barrier ribs 140 may be configured in any suitable arrangement, e.g., a matrix pattern, in order to form the plurality of discharge cells 170. The discharge cells 170 may have any suitable geometrical cross-section in the xy-plane, such as a polygon, e.g., a rectangular cross-section, a circle, an oval, and so forth.

The discharge cells 170 of the PDP 100 may include red, green, and blue discharge cells 170R, 170G, and 170B, so that respective red, green, and blue lights may be emitted therefrom upon application of voltage to discharge gas, e.g., neon (Ne), xenon (Xe), helium (He), or combinations thereof, in each discharge cell 170. The discharge cells 170 may be configured into arrays of uniform colors, e.g., an array of blue discharge cells 170B, along the y-axis, while the red, green, and blue discharge cells 170R, 170G, and 170B may be arranged in a repetitive color pattern along the x-axis.

The discharge electrodes 130 of the PDP 100 may be on an inner surface of the first substrate 110. The discharge electrodes 130 may include pairs of an X electrode 135x and a Y electrode 135y, so that an array of discharge cells 170 along the x-axis may be positioned between a X electrode 135x and a Y electrode 135y of a single pair of discharge electrodes 130. The X electrode 135x may include at least one X transparent electrode 133x and a X bus electrode 131x, and the Y electrode 135y may include at least one Y transparent electrode 133y and a Y bus electrode 131y.

The X and Y transparent electrodes 133x and 133y may initiate and sustain a discharge in the discharge cells 170, and may be formed of a material exhibiting high visible light transmittance and low resistance, e.g., indium tin oxide (ITO). Accordingly, each pair of X and Y transparent electrodes 133x and 133y may correspond to a respective single discharge cell 170. X and Y bus electrodes 131x and 131y may correspond to an array of discharge cells 170 along the x-axis, and may be connected to a plurality of respective X and Y transparent electrodes 133x and 133y. The X and Y bus electrodes 131x and 131y may compensate for the high resistance of the X and Y transparent electrodes 133x and 133y, thereby providing a substantially similar voltage application to the plurality of the discharge cells 170. The X and Y bus electrodes 131x and 131y may be formed along the x-axis of metal, e.g., chromium (Cr), copper (Cu), aluminum (Al), etc.

The plurality of address electrodes 160 of the PDP 100 may extend on an inner surface of the second substrate 115 along respective arrays of discharge cells 170 along the y-axis, i.e., each address electrode 160 may extend along a single array of discharge cells 170 emitting a specific color of light. More specifically, the address electrodes 160 may include a plurality of first address electrodes 160G, second address electrodes 160R, and third address electrodes 160B. Accordingly, the first address electrodes 160G may correspond to an array of the green discharge cells 170G, the second address electrodes 160R may correspond to an array of the red discharge cells 170R, and the third electrodes 160B may correspond to an array of the blue discharge cells 170B. Therefore, the first, second, and third address electrodes 160G, 160R, and 160B may be configured to alternate along the x-axis with respect to the color configuration of the discharge cells 170. For example, each first address electrode 160G may be between second and third address electrodes 160R and 160B with respect to the x-axis, as illustrated in FIG. 1.

The first address electrodes 160G may be positioned on a different vertical plane as compared to the second and third address electrodes 160R and 160G. The second and third address electrodes 160R and 160B may or may not be disposed on the same vertical plane. More specifically, all address electrodes 160 may be disposed in the xy-plane. However, a vertical position, i.e., a vertical plane, of each address electrode 160 may vary along the z-axis.

For example, the first address electrodes 160G may be positioned vertically further from the discharge electrodes 130 as compared to the second and third address electrodes 160R and 160B. More specifically, as illustrated in FIG. 2, the first address electrodes 160G may be positioned on the second substrate 115 at a first distance D1 with respect to a protective layer 125. The second and third address electrodes 160R and 160B may be disposed on the same vertical plane between first and second lower dielectric layer portions 151 and 153, at a second distance D2 with respect to the protective layer 125. The first distance D1 may be larger than the second distance D2 as measured along the z-axis between inner surfaces of the protective layer 125 and each of the address electrodes 160. In this respect, it should be noted that the protective layer 125 may have a substantially uniform thickness, and therefore, the protective layer 125 and the discharge electrodes 130 may be used interchangeably to define relative vertical positions of the address electrodes 160.

Each first address electrode 160G may have a first width W1, i.e., a distance as measured along the x-axis. Each of the second and third address electrodes 160R and 160B may have a second width W2. The first width W1 may be larger than the second width W2. The first address electrodes 160G may have a greater surface area than the second and third address electrodes 160R and 160B.

Without intending to be bound by theory, it is believed that adjusting surface areas and/or widths of the address electrodes 160 with respect to vertical positions thereof may provide uniform address discharge generation in the discharge space of the PDP 100, despite non-uniform distance of the address electrodes 160 with respect to the discharge electrodes 130. In other words, the larger width of the first width W1 may compensate for the larger distance between the first address electrodes 160G and the discharge electrodes 130, thereby providing a discharge comparable to the discharge generated between the second/third address electrodes 160R/160B and the discharge electrodes 130. Further, even with an increased number of address electrodes 160 in the PDP 100, short circuits therebetween may be minimized due to varying of vertical positioning of the first, second, and third address electrodes 160G, 160R, and 160B.

The PDP 100 may further include photoluminescent layers 180, e.g., phosphorescent material, in the discharge cells 170. More specifically, red photoluminescent layers 180R, green photoluminescent layers 180G, and blue photoluminescent layers 180B may be disposed in respective red, green, and blue discharge cells 170R, 170G, and 170B. The red photoluminescent layers 180R may include a red photoluminescent material, e.g., Y(V,P)O₄:Eu. The green photoluminescent layers 180G may include a green photoluminescent material, e.g., Zn₂SiO₄:Mn or YBO₃:Tb. The blue photoluminescent layers 180B may include a blue photoluminescent material, e.g., BAM:Eu.

Further, the PDP 100 may include an upper dielectric layer 120 on the first substrate 110. The upper dielectric layer 120 may be formed between the first substrate 110 and the protective layer 125 to cover the discharge electrodes 130. The upper dielectric layer 120 may limit a discharge current, sustain a discharge glow, accumulate wall charges to provide a memory function, and reduce voltage. The upper dielectric layer 120 may be formed of a transparent high-dielectric material, e.g., a mixture of PbO—B₂O₃—SiO₂. The upper dielectric layer 120 may be shielded from collision with charged particles by the protective layer 125, i.e., the protective layer 125 may be formed of magnesium oxide (MgO) on the upper dielectric layer 120 to shield the upper dielectric layer 120 and to reduce discharge voltage via secondary electron emission.

The first and second lower dielectric layer portions 151 and 153 of the PDP 100 may be formed of the same material. The first and second lower dielectric layer portions 151 and 153 may form a lower dielectric layer 150. The lower dielectric layer 150 may be formed so that the first lower dielectric layer portion 151 may be disposed on the first address electrodes 160G, and the second lower dielectric layer portion 153 may be disposed on the second and third address electrodes 160R and 160B.

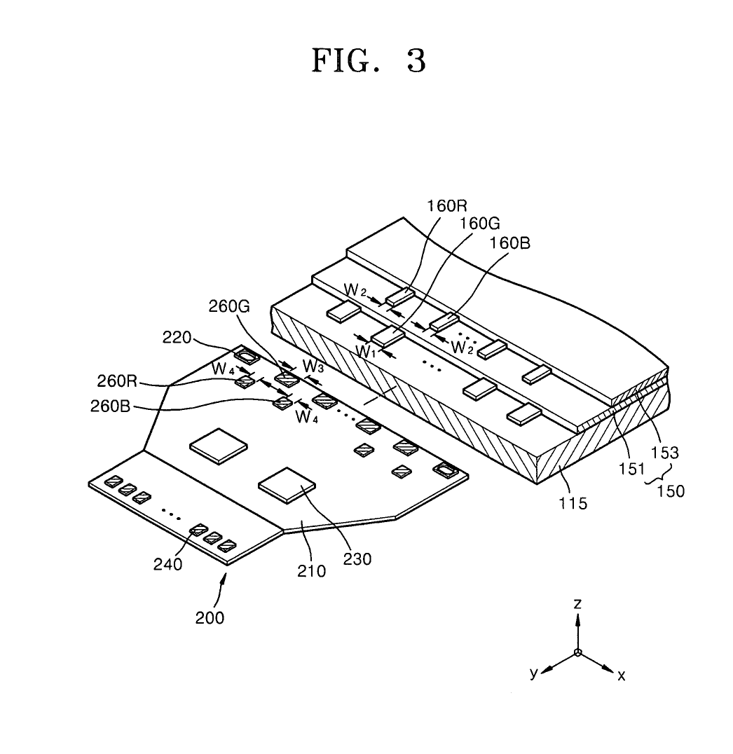

The PDP 100 may be driven via a signal transmission element 200, as illustrated in FIG. 3. More specifically, the signal transmission element 200 may be connected to an edge of the PDP 100 via the address electrodes 160, as further illustrated in FIG. 3. However, other configurations, e.g., an electrical connection between the signal transmission element 200 and the discharge electrodes 130 of the PDP 100 are within the scope of the present invention.

As illustrated in FIG. 3, an outer edge of the PDP 100 may include layers and electrodes of different lengths, so that end points of the address electrodes 160 may be exposed through different layers of the outer edge of the PDP 100. More specifically, the second substrate 115, the first lower dielectric layer portion 151, and the second lower dielectric layer portion 153 may have sequentially decreasing lengths along the y-axis. Accordingly, a portion of the second substrate 115 may extend beyond the first lower dielectric layer portion 151 along the y-axis, and a portion of the first lower dielectric layer portion 151 may extend beyond the second lower dielectric layer portion 153 along the y-axis. Further, the first address electrodes 160G may be longer that the second and third address electrodes 160R and 160B along the y-axis.

Therefore, as further illustrated in FIG. 3, end points of the first address electrodes 160G may be exposed on the second substrate 115 due to a shorter length of the first lower dielectric layer portion 151. In other words, the first lower dielectric layer portion 151 may be applied above the first discharge electrodes 160G only in areas corresponding to the discharge cells 170, as illustrated in FIG. 1, so that end points of the first address electrodes 160G, i.e., peripheral portions with respect to the discharge cells 170, may be exposed to an exterior of the PDP 100. Similarly, end points of the second and third address electrodes 1 60R and 1 60B may be exposed on the first lower dielectric layer portion 151 due to a shorter length of the second lower dielectric layer portion 153 thereon. Accordingly, the signal transmission element 200 may be connected to the exposed end points of the first, second, and third address electrodes 160G, 160R, and 160B.

The signal transmission element 200 may include a plurality of first, second, and third terminals 260G, 260R, and 260B on a base member 210. The first, second, and third terminals 260G, 260R, and 260B may be on a same vertical plane or not.

The first terminals 260G may be offset with respect to the second and third terminals 260R and 260B. For example, as illustrated in FIG. 3, all the first terminals 260G may be aligned along an outer edge of the signal transmission element 200, i.e., along the x-axis, with predetermined intervals therebetween, so that the second and third terminals 260R and 260B may be arranged alternately in parallel to the first terminals 260G and with a predetermined shift along the y-axis and the x-axis with respect to the first terminals 260G.

Further, each of the first terminals 260G may have a third width W3 that is larger than a fourth width W4 of the second and third terminals 260R and 250B as measured along the x-axis. Preferably, the third and fourth widths W3 and W4 of the first, second, and third terminals 260G, 260R, and 260B may substantially equal the first and second widths W1 and W2 of the first, second, and third address electrodes 160G, 160R, and 160B. As such, the geometrical configuration of the first, second, and third terminals 260G, 260R, and 260B may correspond to the geometrical configuration, e.g., different widths and vertical positions, of the first, second, and third address electrodes 160G, 160R, and 160B.

The base member 210 of the signal transmission element 200 may be formed in any suitable shape of a flexible material, e.g., a ceramic film. Accordingly, the first, second, and third terminals 260G, 260R, and 260B may be connected to the first, second, and third address electrodes 160G, 160R, and 160B, respectively, even if the first, second, and third terminals 260G, 260R, and 260B are on the same vertical plane. In this respect, it should be noted that the alternating and shifting configuration of the first, second, and third terminals 260G, 260R, 260B on the base member 210 may provide sufficient space therebetween, so that potential electric shorts may be minimized.

The signal transmission element 200 may further include alignment marks 220, at least one driving integrated circuit (IC) 230 on the base member 210, leads buried inside the base member 210 (not shown), and lead terminals 240. The alignment marks 220 may facilitate alignment between the address electrodes 160 and the terminals 260G, 260R, 260B. The lead terminals 240 may be exposed outwardly.

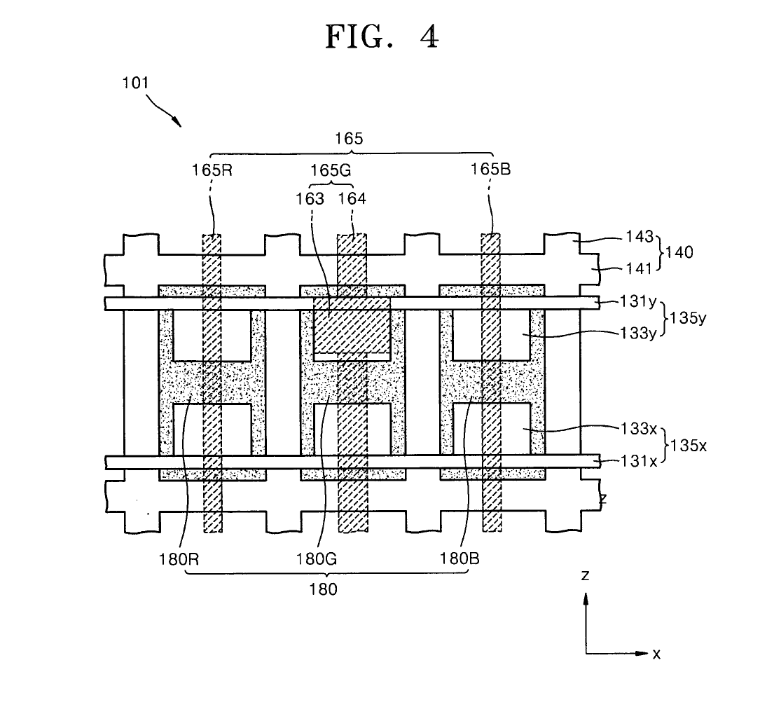

According to another embodiment of the present invention illustrated in FIG. 4, a PDP 101 may be substantially similar to the PDP 100 described previously with respect to FIGS. 1-3, with the exception of including first address electrodes 165G having linear extensions 164 and protrusions 163. The second and third address electrodes 165R and 165B may only include linear extensions 164. In other words, the second and third address electrodes 165R and 165B may be substantially similar to the first and second address electrodes 160R and 160B described previously with respect to FIGS. 1-3, and therefore, their detailed description will not be repeated herein. Additionally, the relative positioning of each of the first, second, and third address electrodes 165G, 165R, and 165B on the second substrate 115 may be substantially similar to the vertical positioning of the first, second, and third address electrodes 160G, 160R, and 160B, respectively, described previously with respect to FIGS. 1-3. Accordingly, detailed description of the vertical positioning of the address electrodes 165 will not be repeated herein.

As illustrated in FIG. 4, the first address electrodes 165G may include linear extensions 164 extending in parallel to the second barrier ribs 143, i.e., each linear extension 164 may cross a respective array of discharge cells 170 along the y-axis. The protrusions 163 of the first address electrodes 165G may be connected to the linear extensions 164 under the barrier rib 140. In an implementation, the protrusions 163 may substantially correspond to the Y transparent electrodes 133y in shape, e.g., a rectangle, size, and positioning, so that each protrusion 163 may form a substantially overlapping plane with respect to the corresponding Y transparent electrode 133y. For example, each discharge cell 170 corresponding to a first address electrode 165G may include a predetermined space defined between a protrusion 163, i.e., a lower plane, and a corresponding respective Y transparent electrode 133y, i.e., an upper plane. The protrusions 163 and the Y transparent electrodes 133y may be positioned in parallel planes, i.e., spaced apart along the z-axis.

Each first address electrode 165 may include a plurality of protrusions 163. Accordingly, the protrusions 163 may significantly enlarge an overall size, i.e., surface area, of each first address electrode 165G, as compared to each of the second and third address electrodes 165R and 165B. The increased size of the first address electrodes 165G may increase an amount of address discharge generated by the first address electrodes 165G. Accordingly, the increased address discharges generated by the first address electrodes 165G due to the size thereof may compensate for the larger distance between the first address electrode 165G and the Y bus electrodes 135y, as compared to the distance between the second/third address electrodes 165R/165B and the Y bus electrodes 135y. In other words, formation of the first address electrodes 165G to include the protrusions 163 may facilitate generation of a substantially uniform address discharge among the first, second, and third address electrodes 165G, 165R, and 165B.

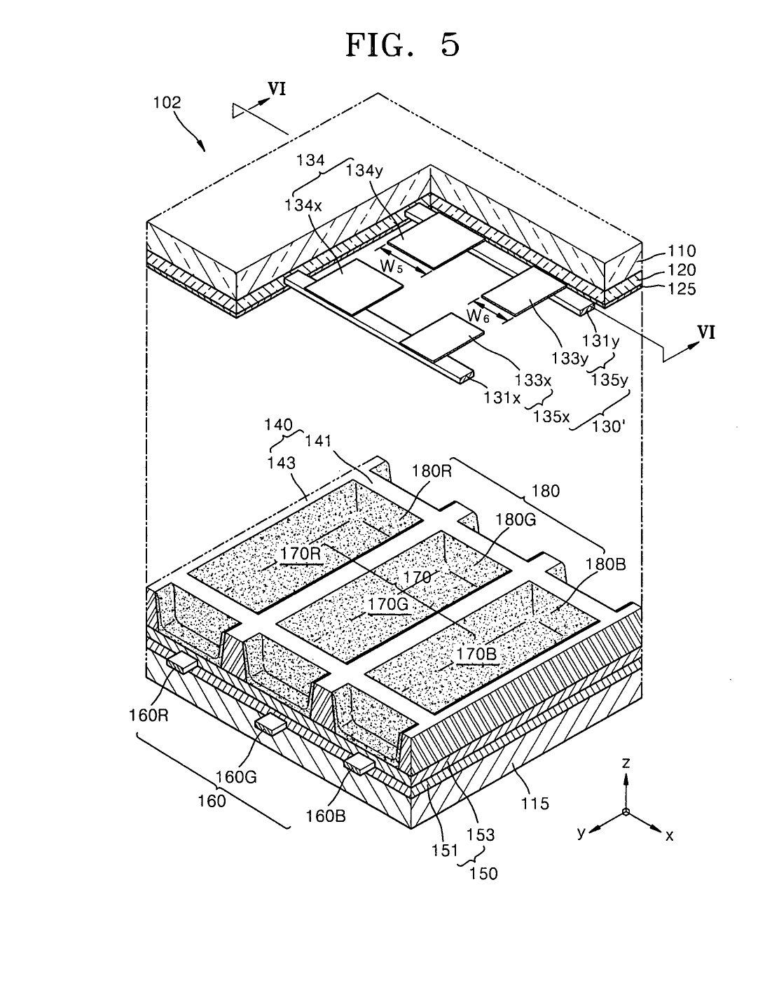

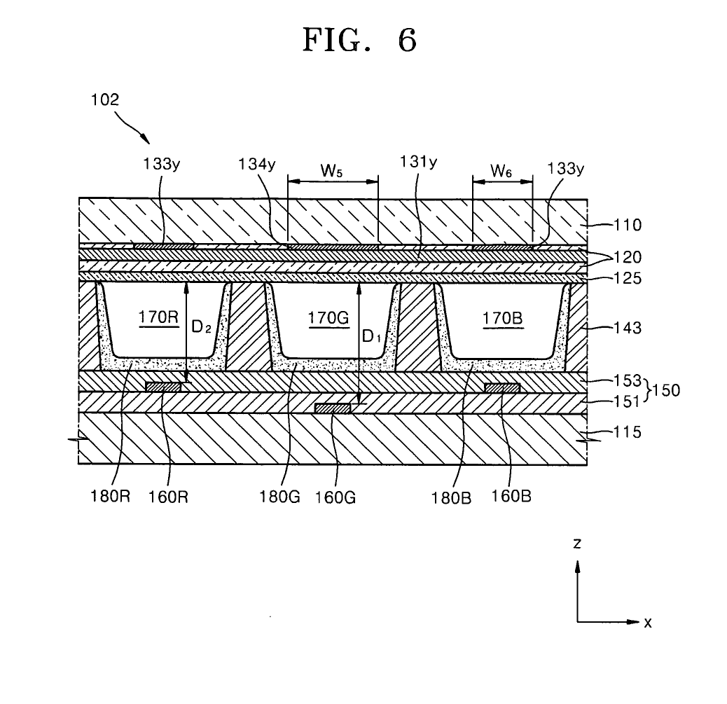

According to yet another embodiment of the present invention illustrated in FIGS. 5-6, a PDP 102 may be substantially similar to the PDP 100 described previously with respect to FIGS. 1-3, with the exception of including discharge electrodes 130′ having the transparent electrodes 133, as well as second transparent electrodes 134. Transparent electrodes 133 will be referenced hereinafter as “first” transparent electrodes 133 for clarity.

The discharge electrodes 130′ of the PDP 102 may include pairs of X electrodes 135x and Y electrodes 135y. Each X electrode 135x may include a X bus electrode 131x, a plurality of first X transparent electrodes 133x, and a plurality of second X transparent electrodes 134c. Similarly, each Y electrode 135y may include a Y bus electrode 131y, a plurality of first Y transparent electrodes 133y, and a plurality of second Y transparent electrodes 134y. The second X and Y transparent electrodes 134c and 134y may be referred to hereinafter collectively as second transparent electrodes 134. The first X and Y transparent electrodes 133x and 133y may be referred to hereinafter collectively as first transparent electrodes 133.

In detail, the discharge electrodes 130′ may be configured so that a pair of the second transparent electrodes 134 may be positioned above each discharge cell 170G in order to correspond to the first address electrodes 160G, as illustrated in FIG. 5. Pairs of the first transparent electrodes 133 may be positioned above discharge cells 170R and 170B, respectively, in order to correspond to the second and third address electrodes 160R and 160B, as further illustrated in FIG. 5. Further, a surface area of each pair of the second transparent electrodes 134 may be larger than a surface area of each pair of the first transparent electrodes 133.

More specifically, the second Y transparent electrodes 134y may have a fifth width W5, and the first Y transparent electrodes 133y may have a sixth width W6.

The sixth width W6 may be smaller than the fifth width W5, thereby facilitating formation of a second Y transparent electrode 134y with a larger surface area, as compared to the first transparent electrode 133y. Accordingly, the increased surface area of the second Y transparent electrodes 134y may increase an amount of discharge between the second Y transparent electrodes 134y and the first address electrodes 160G, thereby compensating for the larger first distance D1 of the first address electrodes 160G and providing an overall substantially uniform discharge via all the address electrodes 160. The surface area of the second X transparent electrodes 134c may be similarly increased, e.g., each of the second X transparent electrodes 134c may have the fifth width W5, while each of the first X transparent electrodes 133x may have the sixth width W6.

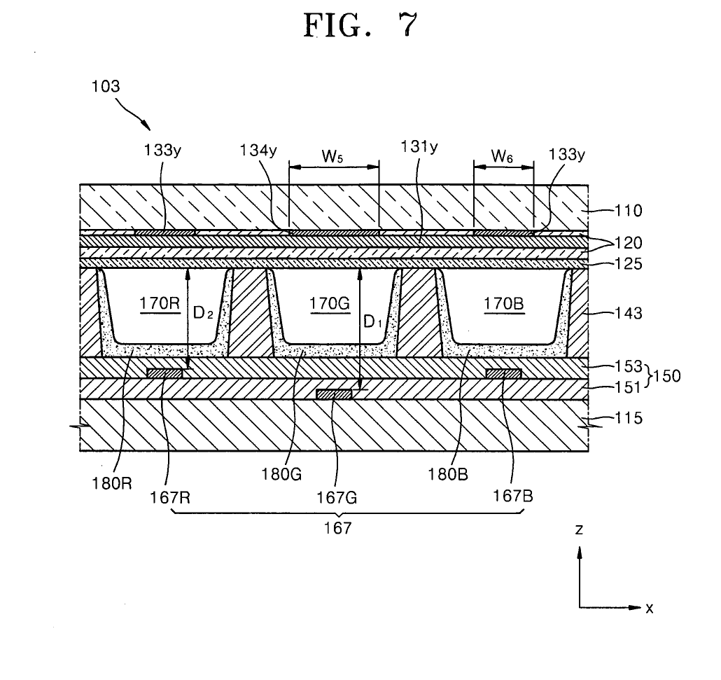

According to yet another embodiment illustrated in FIG. 7, a PDP 103 may be substantially similar to the PDP 102 with the exception of having address electrodes 167. Address electrodes 167 may include first, second, and third address electrodes 167G, 167R, and 167B having a substantially uniform width w. In that case, discharge uniformity may be obtained solely due to adjustment of the surface area of the discharge electrodes 130′ as described above.

Embodiments of the present invention may provide an advantageous structure of a PDP having a reduced horizontal distance, i.e., along the x-axis, between address electrodes, while maintaining uniform discharge therein and reduced risk of short circuit therebetween. The horizontal distance between address electrodes may be reduced by modifying vertical distances therebetween, while discharge therein may be maintained substantially uniform by modifying surface areas of address electrodes with respect to vertical positioning thereof, modifying surface areas of discharge electrodes with respect to vertical positioning of address electrodes, or both. Further, a signal transmission element having terminals with varying widths may be effectively connected to the address electrodes to provide for modified surfaces areas of the address electrodes. As such, a PDP with improved reliability may be provided.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
first and second substrates facing one another;
a plurality of discharge electrodes;
a plurality of first address electrodes, the plurality of first address electrodes having a first surface area and spaced apart from the discharge electrodes by a first vertical distance; and
a plurality of second address electrodes, the plurality of second address electrodes having a second surface area and spaced apart from the discharge electrodes by a second vertical distance, the second surface area and second vertical distance being different than the first surface area and first vertical distance.

2. The PDP as claimed in claim 1, wherein the second vertical distance is shorter than the first vertical distance.

3. The PDP as claimed in claim 2, wherein each first address electrode is adjacent to at least one second address electrode.

4. The PDP as claimed in claim 2, wherein the discharge electrodes include pairs of X electrodes and Y electrodes, each X electrode having a X bus electrode and a plurality of first X transparent electrodes, and each Y electrode having a Y bus electrode and a plurality of first Y transparent electrodes.

5. The PDP as claimed in claim 4, wherein the first surface area of the first address electrodes is larger than a second surface area of the second address electrodes.

6. The PDP as claimed in claim 5, wherein the first address electrodes are wider than the second address electrodes.

7. The PDP as claimed in claim 5, wherein the first address electrodes have different lengths as compared to the second address electrodes.

8. The PDP as claimed in claim 7, wherein the first address electrodes are longer than the second address electrodes.

9. The PDP as claimed in claim 5, wherein the first address electrodes include protrusions protruding from linear extensions.

10. The PDP as claimed in claim 9, wherein the protrusions of the first address electrodes correspond to the first Y transparent electrodes.

11. The PDP as claimed in claim 4, wherein each Y electrode further comprises a plurality of second Y transparent electrodes, the second Y transparent electrodes having a larger surface area than the first Y transparent electrodes.

12. The PDP as claimed in claim 11, wherein the second Y transparent electrodes are wider than the first Y transparent electrodes.

13. The PDP as claimed in claim 12, wherein the second Y transparent electrodes correspond to the first address electrodes.

14. The PDP as claimed in claim 11, wherein each X electrode further comprises a plurality of second X transparent electrodes, the second X transparent electrodes having a larger surface area than the first X transparent electrodes.

15. The PDP as claimed in claim 14, wherein the second X transparent electrodes are wider than the first X transparent electrodes and correspond to the first address electrodes.

16. The PDP as claimed in claim 1, further comprising a lower dielectric layer on the first address electrodes.

17. The PDP as claimed in claim 16, wherein the lower dielectric layer includes a first lower dielectric portion on the first address electrodes and a second lower dielectric portion on the second address electrodes.

18. A plasma display panel (PDP), comprising:
first and second substrates facing one another;
a plurality of first and second discharge electrodes, the plurality of first discharge electrodes having a larger surface area as compared to the second discharge electrodes;
a plurality of first address electrodes spaced apart from the first discharge electrodes by a first vertical distance; and
a plurality of second address electrodes spaced apart from the second discharge electrodes by a second vertical distance, the second vertical distance being shorter than the first vertical distance.

19. The PDP as claimed in claim 18, wherein the first discharge electrodes include first transparent electrodes and the second discharge electrodes include second transparent electrodes, the first transparent electrodes being wider than the second transparent electrodes.

20. A PDP signal transmission element, comprising:
a base member;
at least one driving integrated circuit;
a plurality of first terminals on the base member, the first terminals having a first width; and
a plurality of second terminals on the base member, the second terminals having a second width smaller than the first width.
